(19) United States
(12) Patent Application Publication
(10) Pub. No.: US 2008/0181303 A1
(43) Pub. Date: Jul. 31, 2008

(54) System and method for video compression

(75) Inventors: Kenneth Andam, Highland, UT (US); James M. Jensen, American Fork, UT (US); Jared Weinman, American Fork, UT (US)

Correspondence Address: THORPE NORTH & WESTERN, LLP., P.O. Box 1219, SANDY, UT, 84091-1219, US

(73) Assignee: Worldvuer, Inc., American Fork, UT (US)

(21) Appl. No.: 11/982,727

(22) Filed: Nov. 1, 2007

Related U.S. Application Data
(60) Provisional application No. 60/863,945, filed on Nov. 1, 2006.

(51) Int. Cl. H04B 1/66; H04N 7/12

(52) U.S. Cl. 375/240.08; 382/243; 382/247

(57) ABSTRACT

A system and method are provided for compressing video frames having a plurality of pixels. The video frames are viewable by an end user on a display. The method can include the operation of receiving a color palette from a key frame of video. Then a color value can be identified from the color palette. The pixels within a current frame that use the same color value that has been identified can then be selected. A further operation is grouping a color value together with frame coordinates of each pixel that uses the color value following the color value.

### REFERENCE TO RELATED APPLICATIONS AND CLAIM OF PRIORITY

Priority of U.S. Provisional patent application Ser. No. 60/863,945 filed on Nov. 1, 2006 and entitled “System and Method for Supplying Video Messages” is claimed.

### BACKGROUND

Email systems have become more important to business and personal life than ever. In particular, many businesses rely on email communication to conduct transactions and meet their business objectives quickly. As email use has grown, users have desired greater reliability and functionality from their email systems. However, because legacy email systems are based on older messaging protocols and communication architectures, it has been difficult for the software industry to improve upon existing systems while maintaining compatibility with the legacy email systems. This is due in part to the many older protocols and architectures that are so deeply ingrained into current information technology systems.

Instead of improving text email systems to carry additional multimedia elements, parallel messaging systems have been developed to provide electronic chatting technology, video conferencing, and interaction on graphic whiteboards. The creation of such tools only adds to the cost and complexity of the information technology systems that need to be maintained. In addition, these systems do not necessarily maintain backwards compatibility with present email and messaging systems.

The current de facto standards for email systems use aging Internet protocols that provide little or no security for the transfer of messages. In addition, the legacy email systems do not allow for confirmation of the receipt of messages. Legacy email systems also provide little in the way of security or control for the transfer of messages.

This lack of security in email systems manifests itself in symptoms such as unwanted emails or Spam. Many users desire a system with a better way of coping with the Spam problem. Users would like to only receive emails from contacts they want to receive messages from. In addition, individuals should be able to send emails that are legitimate contacts even when the email is being sent for the first time.

Email systems have remained in the realm of text messages with files that can be attached to the emails. Text messages have been available to be sent through the Internet using email clients since the 1960's and multimedia capabilities have been available on computer systems since the early 1990's. However, combining video and graphic capabilities into useful messaging systems that are easily employed by large groups of people has remained a challenge.

### BRIEF DESCRIPTION OF THE DRAWINGS

FIG. 1 illustrates an example user interface for the video system and method in accordance with an embodiment of the present invention; and

FIG. 2 is a flow chart illustrating a method for compressing video frames in an embodiment of the invention.

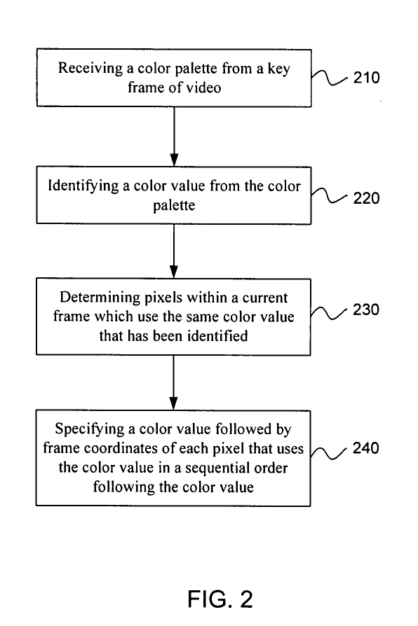

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

A system and method are provided for binding video, audio, and text dialog to designated video conferencing screens within an online video conferencing application. The system contains logic to control the conversion of a video conferencing screen into an integrated embedded chat application with a mini video conferencing screen. Multiple video streams can be delivered into each of four or more separate designated video conferencing screens within a video conferencing application.

The use of multiple video conferencing screens allows an end user to establish a conference with a plurality of users and a plurality of concurrent connections within an online video conferencing application. A private chat conversation can also be initiated with a designated video conferencing participant within a video conferencing event that has a plurality of user participants communicating within the same video conference.

Concurrent video conference participants can be swapped within a designated conference room into any active video conferencing screen without distorting the video and sound quality of the conferencing event. This allows a user to view the participants in any desired order. Simultaneous streams of a plurality of videos in a conferencing session can be delivered without distorting the quality of the audio during the video conference.

User notification can be provided in a video conferencing application using an embedded contacts system integrated into the video conferencing application. The notification is used in establishing whether a user is active or inactive in an online video conferencing application.

A user interface can be provided that comprises menu items, multiple video screens, a my contacts list generator, a rooms center, a universal embedded chat application, a white board tool, a mini video screen with embedded chat, and a current conference designated room control center.

The video conferencing system can be used to create live virtual classrooms for virtual training and education. The event participants can use the real time online video broadcasting to transmit a teaching event to a plurality of event participants. The plurality of event participants can virtually communicate with the event initiator or tutor using a set of embedded visual notification tools and video conference, as well as video chat to participate visually in the event being broadcast.

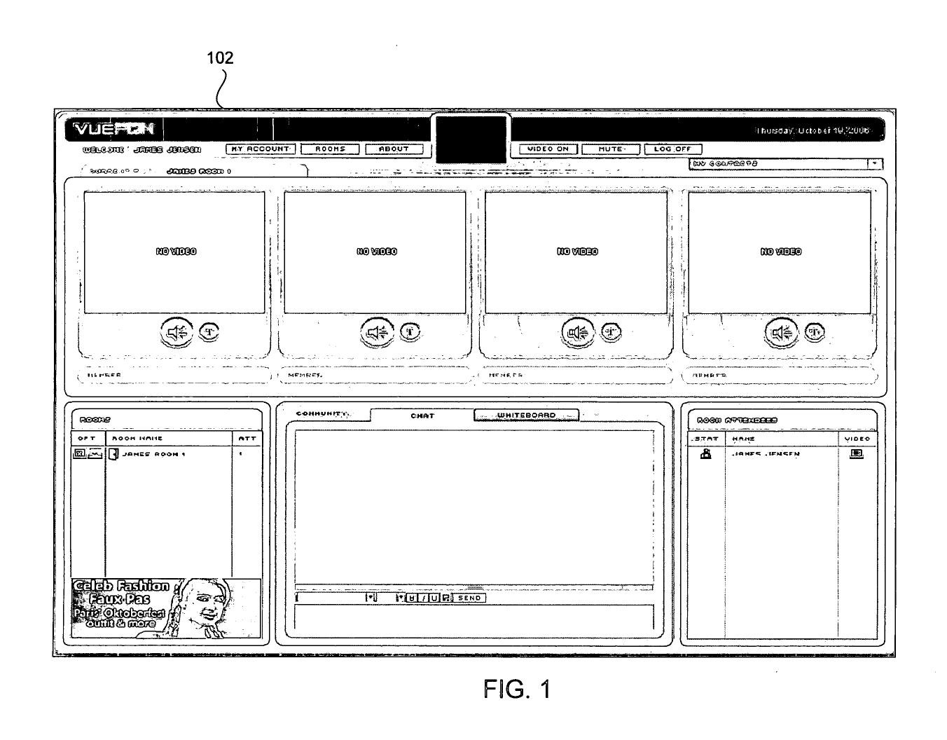

The video conferencing application user interface can be cached locally on a computer for faster generation of pages when requests are invoked in the implementation of the video conferencing application. FIG. 1 illustrates an example interface 102 for the present system and method.

The present system and method can use Index Color Mapped Video (ICMV) for lossless compression for video. Standard video on a computer is represented by mapping a RGB color value over an XY coordinate plane. When the video is represented to a receiving client from a server, each pixel or point location in the image frame may have its own color triplet. This may be as illustrated in Table 1 below:

TABLE 1
{(r, b, g)(x, y)}{(r, b, g)(x, y)}{(r, b, g)(x, y)} {(r, b, g)(x, y)}{(r, b, g)(x, y)}{(r, b, g)(x, y)}
{(r, b, g)(x, y)}{(r, b, g)(x, y)}{(r, b, g)(x, y)} {(r, b, g)(x, y)}{(r, b, g)(x, y)}{(r, b, g)(x, y)}
{(r, b, g)(x, y)}{(r, b, g)(x, y)}{(r, b, g)(x, y)} {(r, b, g)(x, y)}{(r, b, g)(x, y)}{(r, b, g)(x, y)}
{(r, b, g)(x, y)}{(r, b, g)(x, y)}{(r, b, g)(x, y)} {(r, b, g)(x, y)}{(r, b, g)(x, y)}{(r, b, g)(x, y)}
{(r, b, g)(x, y)}{(r, b, g)(x, y)}{(r, b, g)(x, y)} {(r, b, g)(x, y)}{(r, b, g)(x, y)}{(r, b, g)(x, y)}
{(r, b, g)(x, y)}{(r, b, g)(x, y)}{(r, b, g)(x, y)} {(r, b, g)(x, y)}{(r, b, g)(x, y)}{(r, b, g)(x, y)}

With ICMV, instead of passing each color value per coordinate for every frame sent, a color pallet from the first frame of a video or a key changing frame is generated for the video data. Next, the points or pixels within the frame that use the same color value are determined or identified. Then, the color index value is specified and followed by the points or pixels that use that color value in a sequential order. This allows the video frame data to specify the color index once, followed by several points. The video that can be sent to the client can be then represented as below:

TABLE 2

{i}(x, y) (x, y) (x, y) (x, y) (x, y) (x, y)
{i}(x, y) (x, y) (x, y) (x, y) (x, y) (x, y)
{i}(x, y) (x, y) (x, y) (x, y) (x, y) (x, y)
{i}(x, y) (x, y) (x, y) (x, y) (x, y) (x, y)
{i}(x, y) (x, y) (x, y) (x, y) (x, y) (x, y)
{i}(x, y) (x, y) (x, y) (x, y) (x, y) (x, y)

### Compression Comparison

Now compare standard video representation with ICMV for a 100 pixel image with a single color. Referring to Table 1, it takes 5 values to represent a single pixel, and then if you look at Table 2, you can see that it takes only 2 values to represent a single pixel, plus one per color index. So then you can do the following math to get the representation:

Standard Video Size for 100 Pixels

(100 pixels)*(5 color and coordinate values)=500 pixel values

ICMV Size for 100 Pixels

(100 pixels)*(2 coordinate values)+(1 color index value)=201 pixel values

So now you can see that the compression difference is approximately ⅖ this means that a 640×480 video can be stored as a 256×182 video, or inversely, a 640×480 video can be blown up to a 1600×1200 video without losing any quality at all.

### Distributed Processing for Video Conferencing

With ICMV, distributed processing for video conferencing becomes more effective. If 4 computers are connected to a server that is hosting a video conference, two types of calculations need to take place. The first calculation is the calculation to create the ICMV video format, and the second calculation would be to restore video from the ICMV format.

Using this new format, the computer sending the video can perform the required calculations to generate the ICMV format, and then the computer receiving the video performs the calculations required to display the video. This leaves the server to act as just a relay between the four machines and not perform any processing. This not only reduces the needed processing power for the server, but will also reduce latency in the video transfer from the client to server, then client again. The benefits of this type of video conferencing are tremendous.

### Additional ICMV Compression

The first step in ICMV was to isolate colors from pixel coordinates on the screen, and transfer the information independently. ICMV can also be used to apply equations to areas of the video instead of tracking individual coordinates.

If an image is broken down into similar polygons of color, then an equation is determined for the application of each color across the polygon, we can exponentially decrease the size of the video. An example of this is below:

r=x²+y−3

b=x³+y/5

g=6x+y²

As an additional step, binary patterns can be identified in the generated code and the indexed compression can be applied again.

A method for compressing video frames having a plurality of pixels viewable by an end user on a display is also described here. The method can include the operation of receiving a color palette from a key frame of video, as in block 210. The color palette can be computed from an incoming key frame of video using a video processing module that determines which frames are key frames and finds the color palette from each key frame.

Next a compression module can identify a color value from the color palette, as in block 220. The color palette will contain only colors that are actually used in the video frame. The compression module can determine or find pixels within a current frame which use the same color value that has been identified, as in block 230. For example, if a certain shade of red is in the color palette, then all the pixels (i.e., points or picture elements) that match the shade of red will be identified. The pixels can be identified by frame coordinates.

A compressed frame can then be generated by specifying a color value followed by frame coordinates of each pixel that uses the color value in a sequential order following the color value, as in block 240. In other words, each separate color value in the color palette is grouped together with frame coordinates of pixels of the same color value. As a result, each color value in the color palette will be stored in the frame information only once. The compressed frame can then be written to a file or sent across a network in packets to a client computer for viewing by an end user.

In one embodiment, a tag can be placed before each color value in the color palette. This tag may represent that a color value group is beginning. As discussed, the tag and color value will then be followed by only the pixels using the same color value that is listed before the pixels.

Periodically, the key frame of video will change as the video scene changes. When the key frame changes the color palette can also be changed for the video compression system. The color system can also use a color index for the color value. Then when the video frame is displayed the color index can be used to look up the actual color value to be displayed.

In another embodiment of the system and method, an area within a current frame can be identified where the pixels use the same color value. This way an entire area description can be grouped together with a color value as opposed to grouping pixel location values together with the color. The area description can be a geometric, algebraic, vector based or another form of describing the area containing a single color. In a hybrid form of the system and method, the color values can be grouped together with both representations of pixels. The color values can be grouped with area descriptions and with individual pixel coordinate descriptions.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

1. A method for compressing video frames having a plurality of pixels viewable by an end user on a display, comprising:
receiving a color palette from a key frame of video;
identifying a color value from the color palette;
determining pixels within a current frame which use the same color value that has been identified; and
grouping a color value together with frame coordinates of each pixel that uses the color value following the color value.

2. A method as in claim 1, further comprising the step of tagging each color value in the color palette, wherein each color value is followed by only the pixels using the color value from the color palette.

3. A method as in claim 1, further comprising the operation of specifying the each color value in the color palette once and each color value is grouped together with frame coordinates of pixels of the same color value.

4. A method as in claim 1, further comprising the step of changing the color palette when a new key frame of video is received.

5. A method as in claim, further comprising the step of using a color index for the color value.

6. A method for compressing video frames having a plurality of pixels, comprising:
determining a color palette from a key frame of video;
identifying a plurality of color values from the color palette;
determining an area description within a current frame where pixels use the same color value; and
specifying a color value followed by an area description containing the pixels using the color value.

7. A method as in claim 6, further comprising the step of identifying a geometric area for pixels that use the same color value.

8. A method as in claim 7, further comprising the step of identifying individual pixels that have the same pixel values as the geometric areas and grouping the individual pixels with the geometric areas.

9. A method as in claim 6, further comprising the step of mathematically describing the area description.

10. A method as in claim 6, further comprising the operation of specifying the each color value in the color palette once and each color value grouping a color value together with pixels that use the color value.

11. A method as in claim 6, further comprising the step of changing the color palette when a new key frame of video is received.

12. A method as in claim, further comprising the step of using a color index for the color value.
